(19) United States
(12) Patent Application Publication
(10) Pub. No.: US 2014/0348990 A1
(43) Pub. Date: Nov. 27, 2014

(54) Systems and Methods for Heating Liquid, Semi-Solid or Liquid/Solid Combination Comestibles in Combination Microwave and Convection Ovens

(71) Applicant: Campbell Soup Company, Camden, NJ (US)

(72) Inventors: Rasheed Mohammed, Sicklerville, NJ (US); Adrienne Lynn Sienkowski, Alpharetta, GA (US); Talia Salamon-Hickey, Marlton, NJ (US); Mohammed Karkache, Deptford, NJ (US); Mark R. Watts, Marlton, NJ (US); Amanda Zimlich, Media, PA (US); Allan Sinclair, Cambridge (GB); Chris Dawson, Cambridge (GB); James Howarth, Cambridge (GB); William Cramer, Cambridge (GB); John Baranowski, Bensalem, PA (US)

(73) Assignee: Campbell Soup Company, Camden, NJ (US)

(21) Appl. No.: 14/224,968

(22) Filed: Mar. 25, 2014

Related U.S. Application Data
(63) Continuation of application No. PCT/US2012/056551, filed on Sep. 21, 2012.
Application No. PCT/US2012/056551 is a continuation-in-part of application No. 13/246,016, filed on Sep. 27, 2011.

(51) Int. Cl. A47J 36/02; A23L 1/01

(52) U.S. Cl. CPC A47J 36/027; A23L 1/0128
USPC 426/241; 219/734; 219/735

(57) ABSTRACT

A system is provided for heating a comestible. The system includes a container and a flexible vented package containing a liquid, semi-solid or liquid/solid combination comestible. The package is positioned within the container in a manner that hinders the comestible from escaping through the package's vent(s). The container is penetrable to microwaves and is adapted to not experience heat-induced damage when subjected to a heating cycle in a combination microwave and convection oven. The container is adapted to protect the package from heat-induced damage when the container is subjected to a heating cycle in a combination microwave and convection oven.

### BACKGROUND OF THE INVENTION

This application is a continuation of PCT application serial number PCT/US2012/056551, filed Sep. 21, 2012 which claims priority to U.S. application Ser. No. 13/246,016, filed Sep. 27, 2011, the contents of both applications are herein incorporated by reference.

### FIELD OF INVENTION

This invention relates to products and methods for heating comestibles. More particularly, this invention relates to containers and packages that may be used to heat liquid, semi-solid or liquid/solid combination comestibles, e.g., in combination microwave and convection ovens.

### DESCRIPTION OF RELATED ART

Soups, sauces, chilis, and other such liquid, semi-solid or liquid/solid combination comestibles are often served in eating establishments, e.g., restaurants and cafeterias. Many eating establishments, especially quick service restaurants (QSR), do not prepare such foods from scratch. Rather, eating establishments often heat up ready-made liquid, semi-solid or liquid/solid combination comestibles that were previously prepared and cooked by comestible manufacturers. These comestibles are often packaged and stored at room temperature or are refrigerated or frozen until they are ready to be heated and served.

Eating establishments may use any of a number of different modalities to heat liquid, semi-solid or liquid/solid combination comestibles. For example, large amounts of soup are often heated at one time in a large pot on a stove or warmer and then transferred to soup bowls, one serving at a time. However, heating a large amount of soup takes a long time. Often, the soup is maintained at a hot temperature for hours until all of it is served or any remaining portion is disposed of. The result is an over-cooked product, much of which goes to waste. In addition, the pot, utensils and soup bowls (unless disposable) will need to be cleaned after use. While microwave ovens may be used to heat such comestibles, a significant number of eating establishments, especially in the QSR segment, do not have microwave ovens.

Increasingly, eating establishments are using combination microwave and convection ovens, such as those sold under the trademark TURBOCHEF®, to cook or reheat essentially solid comestibles. Combination microwave and convection ovens use both microwave energy and convection heating to enable rapid and convenient cooking and heating of comestibles. For example, such ovens can quickly warm hoagies and grinders, leaving the bread crispy rather than soft or soggy, as would be the likely result using a microwave oven alone.

Notwithstanding their increasing popularity in eating establishments, combination microwave and convection ovens are not used to heat liquid, semi-solid or liquid/solid combination comestibles because there are currently no feasible means to do so, especially in the QSR setting. Typical microwaveable cookware, such as ceramics, glass, PYREX®, foams, ovenable plastics, or ovenable paper/paperboard, are not practical and in some cases unsuitable for heating soups and the like in combination microwave and convection ovens. Disposable containers made from ovenable paper/paperboard, ovenable plastic and foam can only be used in ambient temperatures of up to about 400° F. Those materials will melt or burn if subjected to the ambient environment of a combination microwave and convection oven, which typically holds at 480° F. or above all day in an eating establishment (especially in a QSR). Thus, while disposable materials are convenient in that they allow for little to no cleanup after use, currently available disposable containers are unfit for direct use in combination microwave and convection ovens.

Ceramics, glass and PYREX®, on the other hand, can withstand ambient temperatures in a combination microwave and convection oven. However, those materials retain a significant amount of heat. Consequently, they can be extremely hot to the touch. In addition, heating comestibles directly in containers made from such reusable materials would require that the containers be cleaned after use. Accordingly, ceramic, glass and PYREX® cookware are inconvenient for an operator to use for heating soups and the like in combination microwave and convection ovens, especially in a QSR setting, where the operator works under tight time constraints. Also, heating soup and the like directly in ceramic, glass or PYREX® cookware in a combination microwave and convection oven can burn or scorch the soup due to the extremely high temperatures in such an oven. Thus, ceramic, glass and PYREX® cookware are not feasible options for an operator, especially in a QSR setting, to deliver a quality product with convenience and speed using a combination microwave and convection oven.

In short, many eating establishments have combination microwave and convection ovens and serve hot liquid, semi-solid or liquid/solid combination comestibles. But such eating establishments tend not to use such ovens to heat such comestibles because there are no practical and disposable means to do so. This is indeed surprising, considering that combination microwave and convection ovens have been commercially available for many years and have greatly increased in popularity in recent years. Accordingly, there is a need for practical systems and methods that enable liquid, semi-solid or liquid/solid combination comestibles to be heated in combination microwave and convection ovens. Such systems and methods should enable rapid and substantially uniform heating of the comestible in a manner that is convenient and would require little to no cleanup. Preferably, such systems and methods would be used for heating single-serving packages of liquid, semi-solid or liquid/solid combination comestibles. More preferably, such systems and methods would provide thermal protection to a single-serve comestible-containing disposable package so that the package can withstand the high ambient temperatures (e.g., 480° F. to 540° F.) in a combination microwave and convection oven.

### BRIEF SUMMARY OF THE INVENTION

Accordingly, there is provided a system for heating a comestible. The system includes a container and a flexible vented package containing a liquid, semi-solid or liquid/solid combination comestible. The package is positioned within the container in a manner that hinders the comestible from escaping through the package's vent(s). The container is penetrable to microwaves and is adapted to not experience heat-induced damage when subjected to a heating cycle in a combination microwave and convection oven. The container is adapted to protect the package from heat-induced damage when the container is subjected to a heating cycle in a combination microwave and convection oven.

In another aspect, there is provided a method of heating a comestible. The method includes subjecting a system to a combination microwave and convection oven heating cycle to heat contents within the system. The system includes a closed container and a flexible package containing a comestible. The package is located within the container. The container is penetrable by microwaves and prevents heat-induced damage to the package during the heating cycle.

### BRIEF DESCRIPTION OF SEVERAL VIEWS OF THE DRAWINGS

The invention will be described in conjunction with the following drawings in which like reference numerals designate like elements and wherein:

FIG. 1 is an isometric view of a vented flexible package containing an essentially liquid comestible.

FIG. 2 is an isometric view of a container of the present invention in an open position.

FIG. 3 is an isometric view of the container of FIG. 2 in a closed position.

FIG. 4 is a simplified partial sectional view of the container along the plane defined by section line IV-IV of FIG. 3.

FIG. 5 is an isometric view of the container of FIG. 2 with the vented flexible pouch of FIG. 1 positioned therein.

FIG. 6 is an isometric view of an alternative embodiment of a container of the present invention in an open position.

FIG. 7 is a side view of the container of FIG. 6 in a closed position.

FIG. 8 is a side view of the container of FIG. 6, with a lid portion slightly raised.

### DETAILED DESCRIPTION OF THE INVENTION

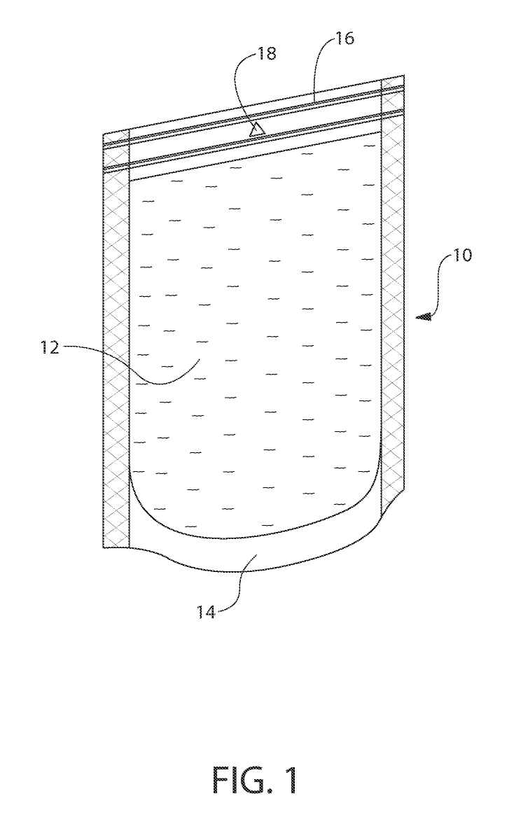

Referring now in detail to the various figures of the drawings wherein like reference numerals refer to like parts, there is shown in FIG. 1 a flexible package 10 containing an essentially liquid comestible 12, e.g., soup. The essentially liquid comestible can be a liquid, a semi-solid or a liquid/solid combination and may, prior to heating, be frozen, refrigerated or at about room temperature. The package 10 is preferably a pliable and disposable plastic vented pouch, such as a multi-layer polymer-based (e.g., PET/CPP) pouch. A preferred package 10 is the pouch sold by Excelsior Technologies Ltd. under the trademark SYSTEAM®. Although the flexible package 10 may be configured to hold several servings of comestible, it is preferred that the package 10 is configured to hold only one serving. The size of one serving can vary depending on the nature of the comestible (e.g., one serving of sauce is typically a smaller amount than one serving of chili or soup). For example, one serving may be anywhere from 1 fl. oz. to 20 fl. oz. But preferably, the package 10 holds from 8 fl. oz. to 12 fl. oz. of comestible and more preferably about 9 fl. oz. to 10 fl. oz. of comestible. In addition, the package 10 should be simple for a user to manually open in order to retrieve the contents therein after heating. For example, the package 10 may include tear notches that enable the user to propagate a tear along a top portion of the package 10.

When filled with comestible 12, the package 10 has a wider bottom portion 14 which tapers to a narrower top portion 16. Near the top portion 16 is a vent 18 that is preferably adapted to provide controlled release of steam and hot air. More preferably, the vent 18 is temperature-sensitive or pressure-sensitive, i.e., it is adapted to open upon either the internal temperature of the package 10 reaching a predetermined level or the internal pressure of the package reaching a predetermined level during heating. For example, the vent may open upon the comestible reaching a temperature of from about 155° F. to about 175° F. or when the package inflates during heating due to increased internal pressure. Alternatively, the vent 18 is a factory-made or user-made opening that is open throughout the heating process. Regardless of the particular embodiment, the vent 18 allows for venting of steam and hot air when the package 10 and comestible 12 are heated.

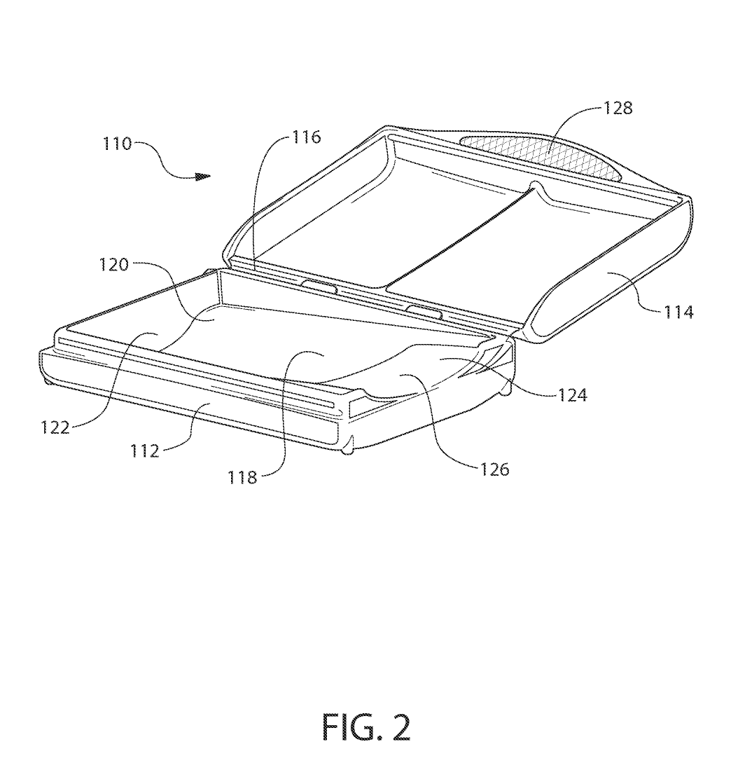

Referring now to FIG. 2, there is shown an isometric view of a container 110 of the present invention in an open position. The container 110 is in the form of a clamshell. While other container forms are contemplated (e.g., containers with separate, removable lids), a clamshell is preferred, among other reasons, because the unitary design prevents a user from losing the lid. The container 110 is preferably made from a high temperature polymer. The high temperature polymer should resist heat-induced damage at ambient temperatures commonly used in a combination microwave and convection oven heating cycle, e.g., from 480° F. to 540° F. The container 110 should also be penetrable by microwaves. Ideally, the container should be made from a durable, reusable material that is capable of being subjected to numerous heating cycles (preferably hundreds or thousands of such cycles) in a combination microwave and convection oven without experiencing heat-induced damage or wear (e.g., burning, melting, warping, etc.). Silicone is a preferred material for the container 110. TEFLON® is also suitable, but other materials that meet the foregoing criteria would suffice.

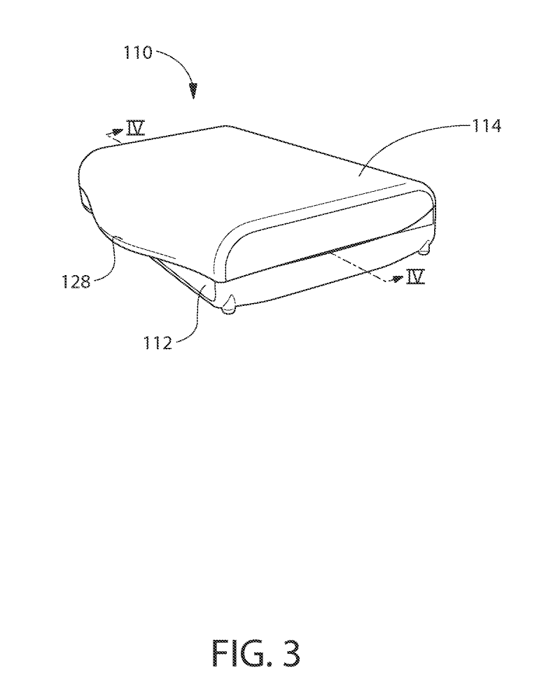

The container 110 includes a base portion 112 and a lid portion 114 pivotally connected thereto by a hinge 116. The hinge 116 enables angled lifting and lowering of the lid portion 114 relative to the base portion 112, i.e., to open and close the container 110. The base portion 112 includes an inner compartment 118 adapted to hold the flexible package 10 of FIG. 1. The inner compartment 118 comprises an angled surface 120 that slopes upwards from a first side 122 towards a second side 124 of the inner compartment 118. The angled surface 120 transitions to an indented surface 126 126 is preferably concave or otherwise configured so as to provide a finger well area to facilitate easy lifting of the package 10 from the container 110 after heating. The lid portion 114 also comprises a handle 128 to enable a user to easily open and close the container 110. FIG. 3 is an isometric view of the container 110 in a closed position.

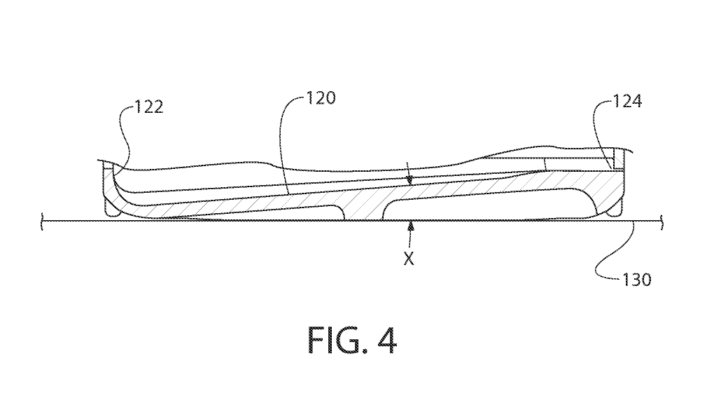

Referring now to FIG. 4, there is shown a partial simplified sectional view of the container 110 along the plane defined by section line IV-IV of FIG. 3. The angled surface 120 has an angle X, which represents the angular measurement between the angled surface 120 and a horizontal plane, e.g., a horizontal surface 130 supporting the container 110 (e.g., an oven rack). The value of X can conceivably range anywhere from greater than 0° to less than 90°. The value of X may vary depending on the dimensions of the inner compartment 118 and the dimensions of the flexible package 10 that the inner compartment 118 is adapted to hold. However, it is contemplated that X should generally be from 5° to 45°, and more preferably about 30°.

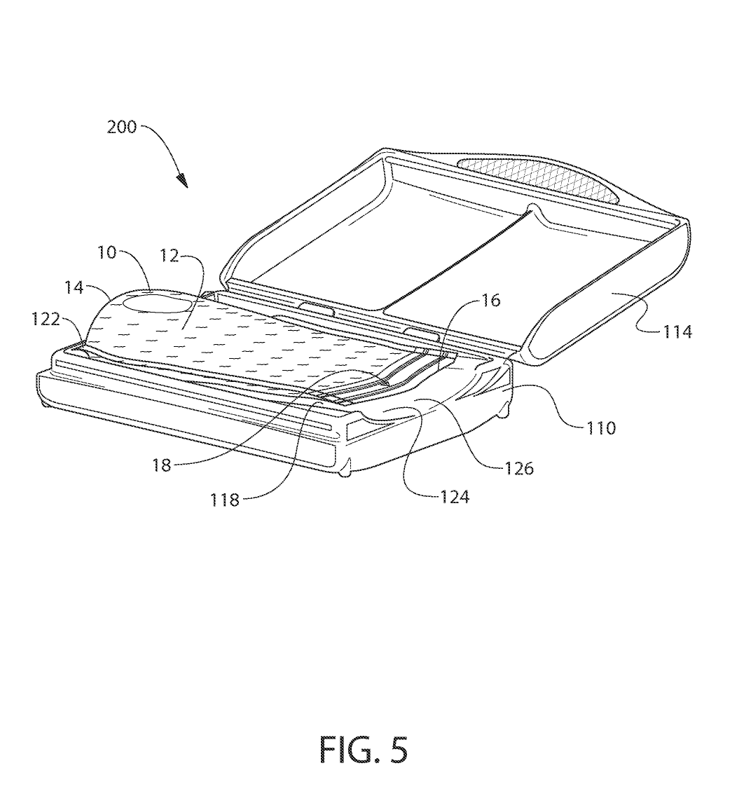

Referring now to FIG. 5, there is shown an isometric view of a system 200 for heating a comestible. The system 200 comprises the container 110 of FIG. 2 and the flexible package 10 of FIG. 1 positioned therein. More specifically, the package 10 is positioned within the inner compartment 118 of the base portion 112 of the container 110. The package 10 rests on the angled surface 120 with the vent 18 facing up. The bottom portion 14 of the package 10 is positioned adjacent to the first side 122 of the inner compartment 118 and the top portion 16 of the package 10 is positioned adjacent to the second side 124 of the inner compartment 118. Thus, the package 10 is oriented at a slight angle in the inner compartment 118. This angular orientation helps to prevent the comestible 12 from flowing towards the top portion 16 of the package 10. In this way, the comestible 12 is hindered (i.e., at least substantially prevented) from escaping through the vent 18. At the same time, the comestible 12 is maintained at a substantially uniform thickness in the package 10 so as to better facilitate quick and uniform heating of the comestible 12. Preferably, the comestible 12 in the package 10 is maintained at an average thickness of approximately one inch or less. More preferably, the comestible 12 is maintained at an average thickness of 0.25 inches to 0.75 inches. Most preferably, the comestible 12 is maintained at an average thickness of 0.5 inches or less.

Once the package 10 is placed in the container 110 as shown in FIG. 5, the container 110 may then be closed as shown in FIG. 3 and placed in an oven, e.g., a combination microwave and convection oven, for heating. A typical heating cycle in a combination microwave and convection oven according to the present invention is ninety seconds or less at an ambient oven temperature of from 480° F. to 540° F.

After a heating cycle in the oven is complete, the container 110 may be opened again as shown in FIG. 5. A user may then manually grasp the top portion 16 of the package 10 to lift and remove the package 10 from the inner compartment 118 of the container. The indented surface 126 adjacent to the second side 124 of the inner compartment 118 provides space for a user to grasp the top portion 16 of the package 10. Also, the top portion 16 of the package 10 would preferably be isolated from the comestible 12 and cool enough for a user to touch (e.g., 150° F. or less) with bare hands after a heating cycle. After the user removes the package 10, he or she may then manually open the package 10 and empty the comestible 12 into a bowl or the like for serving. It is contemplated that the user would dispose of the package 10 after a single use but be able to reuse the container 110 for potentially hundreds or thousands of heating cycles.

Cooking times in a combination microwave and convection oven may vary based on a number of factors, including at least the power of the oven, the amount of comestible being heated, the starting temperature of the comestible and the desired serving temperature of the comestible. However, it is generally contemplated that the system 200 should enable the heating of 8 fl. oz. to 12 fl. oz. of liquid, semi-solid or liquid solid combination comestible from 35° F.-55° F. to 155° F.-175° F. in a combination microwave and convection oven in ninety seconds or less. More preferably, the system 200 would accomplish such heating in one minute or less. In short, the system 200 should enable quick and substantially uniform heating of single servings of refrigerated soups and the like in a combination microwave and convection oven. The system 200 should also prevent heat-induced damage to the package 10 and the comestible 12. Additionally, the system 200 should achieve these objectives in a way that leaves the container 110 clean after use.

Although the inner compartment 118 of the container 110 comprises an angled surface 120 as shown in the drawing figures, it is contemplated that a system according to the present invention may comprise a flat resting surface for a comestible-containing flexible package. Whichever way the container is configured, it should be adapted to position the flexible package in a manner that hinders the comestible from escaping through the package's vent(s). Thus, the container may be configured differently depending on the shape of the package and/or location of the package's vent(s).

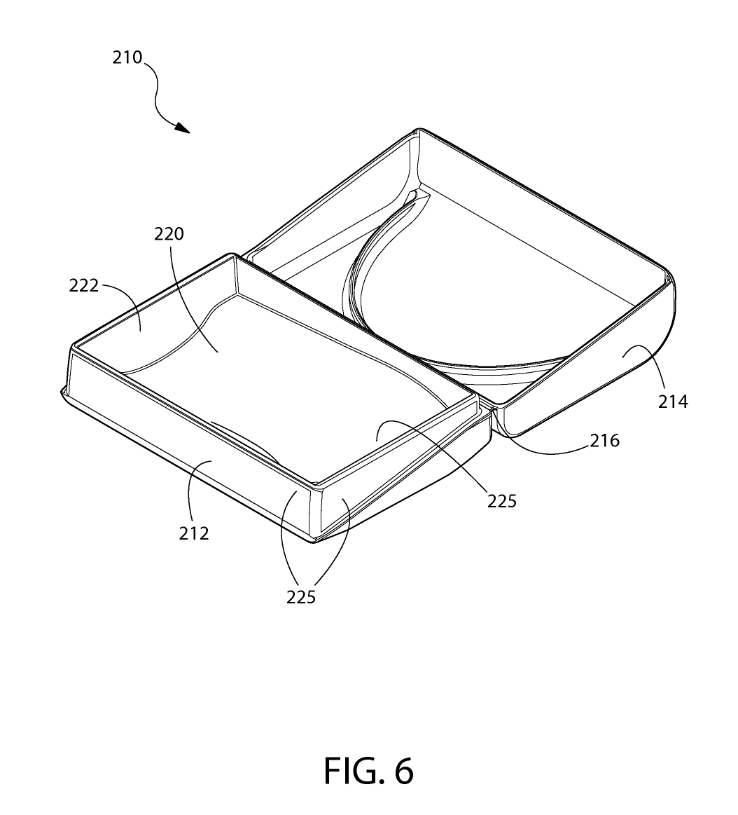

Referring now to FIGS. 6-8, there is shown an alternative embodiment of a container 210 according to the present invention. The container 210, which is in the form of a clamshell, is preferably made of a material having the same physical and chemical properties as the container 110 of FIGS. 2-5. As shown in FIG. 6, the container 210 includes a base portion 212 and a lid portion 214 pivotally connected thereto by a hinge 216. The hinge 216 enables angled lifting and lowering of the lid portion 214 relative to the base portion 212, i.e., to open and close the container 210. The base portion 212 includes an inner compartment 218 adapted to hold the flexible package 10 of FIG. 1. The inner compartment 218 preferably comprises an angled surface 220 that slopes upwards from a first side 222 towards a second side 224 of the inner compartment 218. The slope of the angled surface 220 can be the same as angle X discussed above with respect to the container 110 shown in FIG. 4. In other words, the slope of the angled surface 220 can conceivably range anywhere from greater than 0° to less than 90°. However, it is contemplated that the slope of the angled surface 220 should generally be from 5° to 45°, and in a particularly preferred embodiment, about 11°.

The comestible-containing flexible package 10 of FIG. 1 may be placed inside the container 210 of FIG. 6 in essentially the same manner as the package 10 is positioned within the container 110 of FIG. 5. When the package 10 within the container 210 is subjected to a heating cycle in a combination microwave and convection oven, the increased temperature within the package 10 creates steam and causes the pressure therein to increase. The increased pressure causes the package 10 to inflate. Preferably, once a predetermined pressure level within the package is reached, the vent 18 opens, providing for controlled release of steam and hot air. While the vent 18 releases steam and hot air during a heating cycle, the package 10 remains inflated.

As shown in FIG. 6, the angled surface 220 of the inner compartment 218 of the container 210 is concave in a direction transverse to the slope of the angled surface. This concavity preferably matches, as closely as possible, the shape of the package 10 when the package 10 is inflated during a heating cycle in a combination microwave and convection oven. The base portion 212 of the container 210 includes a wall 225 around the periphery of the inner compartment 218. The wall 225 is preferably of uniform height all the way around.

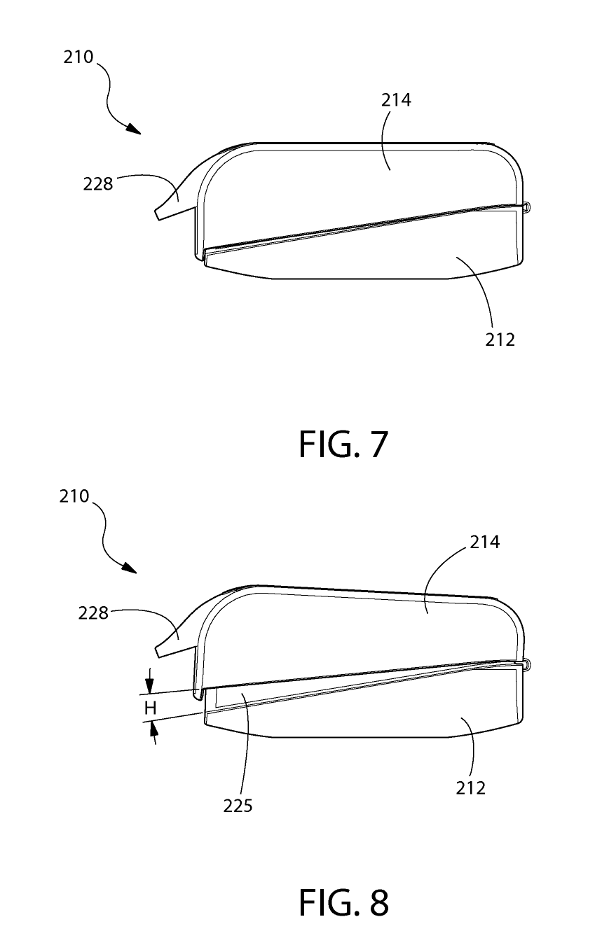

FIG. 7 shows a side view of the container 210 of FIG. 6 in a closed position. The lid portion 214 comprises a handle 228 to enable a user to easily open and close the container 210. As discussed above, a package 10 within the container 210 inflates when subjected to a heating cycle in a combination microwave and convection oven. In one embodiment, as the package 10 inflates during a heating cycle, the package 10 pushes against the lid portion 214, raising the lid portion 214 slightly to a height H, exposing a portion of the wall 225 surrounding the inner compartment 218, as shown in FIG. 8. Though the lid portion 214 is slightly raised, it still overlaps with the wall 225, thereby maintaining a complete enclosure around the inner compartment 218. The wall 225 thus operates to protect the package 10 during a heating cycle by shielding the package 10 from direct exposure to the extremely hot environment in the combination microwave and convection oven, which could otherwise damage the package 10. In other words, when the lid portion 214 is slightly raised, e.g., as shown in FIG. 8, the package 10 is still completely encapsulated by the container 210 and thus protected from experiencing heat-induced damage during a heating cycle in the combination microwave and convection oven.

Preferably, once the heating cycle has ended, if the package 10 had vented properly, the package 10 would have deflated, causing the lid portion 214 to lower back down to the closed position shown in FIG. 7. However, if the package 10 did not properly vent, it may remain inflated, leaving the lid portion 214 slightly raised, e.g., to height H, as shown in FIG. 8. In such a case, the slightly raised lid portion 214 may serve as a visual indicator to an operator that the package 10 is still inflated and that the operator should exercise caution when opening the container 210.

It may be possible, depending on the relative sizes of the package 10 and container 210, that the package 10 inflate within the container 210 during the heating cycle without raising, or perhaps, without even touching the lid portion 214 of the container. For example, a relatively small package 10 may not inflate sufficiently (or at all) during a heating cycle in a combination microwave and convection oven to cause the lid portion 214 to rise at all during the heating cycle. However, it is preferred that there is only minimal empty space in the container 210 when a package 10 is placed therein, in order to accelerate heating of the comestible contained within the package 10. It is contemplated that such minimal empty space is provided, at least in part, by low (or no) clearance between the package 10 and the lid portion 214 when the container 210 is closed as shown in FIG. 7, prior to heating. With this low clearance, inflation of the package 10 during a heating cycle would cause the lid portion 214 to rise, e.g., to height H shown in FIG. 8.

Alternatively, if the package 10 is relatively large and the container 210 is relatively small, the container 210 may not be able to close all the way when the package 10 is positioned therein, even prior to heating. For example, the container 210 may start out with the lid portion 214 slightly raised, e.g., as shown in FIG. 8, prior to heating. Then, during the heating cycle, inflation of the package 10 would cause the lid portion 210 to rise even further. Still, however, it is contemplated that the lid portion 225 would continue to overlap with the wall 225 so as to protect the package 10 from the oven environment.

In yet another alternative embodiment, the package 10 may snugly fit within the container 210, such that the container 210 may be fully closed as shown in FIG. 7. In such a case, inflation of the package 10 during the heating cycle may push against the lid portion 214, leaving the lid portion 214 slightly raised, e.g., to a height H, as shown in FIG. 8, even after the conclusion of the heating cycle. In such circumstances, the raised lid portion 214 may be a visual indicator to an operator that the comestible within the package 10 has been adequately heated and is ready to serve. Thus, for example, if after a heating cycle in a combination microwave and convection oven, the container 210 is still fully closed, e.g., as shown in FIG. 7, the operator will know that something did not go right. For example, the operator would be apprised that either the package 10 did not inflate at all (and thus the comestible was not sufficiently heated), or that the package 19 exploded and scalding hot comestible had leaked or splattered within the container 210.

If an embodiment of the present invention incorporates a visual indicator concerning the state of the package and comestible within the container, it is preferred that the visual indicator be triggered by inflation of the package as a result of being subjected to a heating cycle in a combination microwave and convection oven. It is further preferred that the visual indicator comprise a raised lid portion. Enhancements or alternatives to the visual indicator shown in FIG. 8 are contemplated. For example, the wall 225 may be of a different, contrasting color to the lid portion 214, so that the visual indicator, e.g., the lid portion 214 being raised to height H, is all-the-more apparent to an operator. As discussed above, the visual indicator may mean different things, depending, e.g., on the relative sizes of the comestible-containing package and the container.

In sum, it is preferred that the container 210 be configured to minimize empty space inside when a package 10 is placed therein. Additionally, the container 210 preferably includes a means to shield the package 10 from the harsh environment of the combination microwave and convection oven during a heating cycle. Such means may, e.g., include the wall 225, which surrounds the package 10. It is contemplated that the container 210 would completely encapsulate the package 10 even if the package inflates and the lid portion 214 is raised during the heating cycle.

The invention will be illustrated in more detail with reference to the following Examples, but it should be understood that the present invention is not deemed to be limited thereto.

### EXAMPLES

### Example 1

Twenty-six comestible heating experiments were conducted. For each experiment, a disposable vented plastic pouch containing about 250 grams of soup was placed into a high temperature polymer container. Next, the container/pouch combination was heated (one at a time) in a TURBOCHEF® brand combination microwave and convection oven. The soups varied in terms of broth viscosity and solid ingredients (if any) that were contained in the broth. The following chart summarizes relevant data recorded about each experiment.

| Experiment | Container | Heating Time | Initial Temp. | Final Temp. |
|---|---|---|---|---|
| No. | Material | (seconds) | (deg. F.) | (deg. F.) |
| 1 | TEFLON ® | 60 | 75 | 150 |
| 2 | TEFLON ® | 45 | 75 | 140 |
| 3 | TEFLON ® | 60 | 75 | 165 |
| 4 | TEFLON ® | 60 | 80 | 160 |
| 5 | TEFLON ® | 60 | 74 | 175 |
| 6 | TEFLON ® | 60 | 75 | 177 |
| 7 | TEFLON ® | 45 | 75 | 140 |
| 8 | TEFLON ® | 45 | 75 | 160 |
| 9 | TEFLON ® | 60 | 65 | 165 |
| 10 | TEFLON ® | 60 | 57 | 135 |
| 11 | TEFLON ® | 60 | 67 | 140 |
| 12 | TEFLON ® | 75 | 67 | 180 |
| 13 | TEFLON ® | 50 | 72 | 162 |
| 14 | TEFLON ® | 60 | 40 | 125 |
| 15 | silicone | 60 | 39.5 | 169 |
| 16 | silicone | 60 | 40 | 155 |
| 17 | silicone | 60 | 55 | 171 |
| 18 | silicone | 60 | 55 | 145-150 |
| 19 | silicone | 60 | 55 | 145-150 |
| 20 | silicone | 60 | 55 | 155-160 |
| 21 | silicone | 60 | 55 | 160 |
| 22 | silicone | 60 | 55 | 160 |
| 23 | silicone | 60 | 55 | 155 |
| 24 | silicone | 60 | 40 | 195 |
| 25 | silicone | 60 | 40 | 195 |
| 26 | silicone | 60 | 48 | 162-163 |

As the data in the foregoing chart illustrates, single-servings of soup were heated, using systems and methods of the present invention, in a combination microwave and convection oven. Each serving was heated from refrigerated or room temperatures to hot serving temperatures, generally in one minute or less. These results demonstrate that with the present invention, a user can now quickly and conveniently heat liquid, semi-solid or liquid/solid combination comestibles using a combination microwave and convection oven.

Had the pouch been placed directly into the oven without the thermal protection provided by the high temperature polymer container, the pouch would have rapidly deformed due to the high ambient temperature inside the oven. Had the soup simply been heated directly in the container, the container would have needed to be washed after use—a step that would detract from the convenience and speed that is especially required in a QSR setting. In addition, heating soup directly in the container would likely result in less predictable heating times, less predictable final temperatures and lack of temperature uniformity of the soup in the container. Use of a pouch allows the soup to spread so as to facilitate quick and uniform heating without dirtying the container.

While the invention has been described in detail and with reference to specific examples thereof, it will be apparent to one skilled in the art that various changes and modifications can be made therein without departing from the spirit and scope thereof.

1. A system for heating a comestible, the system comprising a container and a flexible package containing a liquid, semi-solid or liquid/solid combination comestible, the package having one or more vents, the package being positioned within the container in a manner that hinders the comestible from escaping through the one or more vents, the container being penetrable to microwaves, wherein the container is adapted to not experience heat-induced damage when subjected to a heating cycle in a combination microwave and convection oven, the container being adapted to protect the package from heat-induced damage when the container is subjected to a heating cycle in a combination microwave and convection oven.

2. The system of claim 1, wherein the container is made from a polymer resistant to heat-induced damage at an ambient temperature of 540° F.

3. The system of claim 2, wherein the container is made from silicone.

4. The system of claim 1, wherein the container is adapted to not experience heat-induced damaged when subjected to ambient temperatures of from 480° F. to 540° F.

5. The system of claim 1, wherein the one or more vents are adapted to open upon the comestible reaching a temperature of from about 155° F. to about 175° F.

6. (canceled)

7. The system of claim 6, wherein the container is in a form of a clamshell.

8. (canceled)

9. The system of claim 1, wherein the container comprises an inner compartment having a package-supporting surface that is oriented at an angle greater than 0° relative to a horizontal surface supporting the container.

10. The system of claim 9, wherein the package-supporting surface is oriented at an angle of from 5° to 45° relative to the horizontal surface supporting the container.

11. The system of claim 1, wherein the package comprises a grasping portion that is isolated from the comestible, the grasping portion being adapted not to exceed 150° F. upon conclusion of a heating cycle in a combination microwave and convection oven.

12. A method of heating a comestible, the method comprising subjecting a system to a combination microwave and convection oven heating cycle to heat contents within the system, the system comprising a closed container and a flexible package containing a comestible, the package being located within the container, wherein the container is penetrable by microwaves and prevents heat-induced damage to the package during the heating cycle.

13. (canceled)

14. The method of claim 13, the package containing 8 fl. oz.-12 fl. oz. of comestible, wherein the comestible is heated from 35° F.-55° F. to 155° F.-175° F. in 90 seconds or less.

15. The method of claim 14, wherein the comestible is heated from 35° F.-55° F. to 155° F.-175° F. in one minute or less.

16. The method of claim 13, wherein the package comprises a grasping portion that is isolated from the comestible, the grasping portion being adapted not to exceed 150° F. upon conclusion of the heating cycle.

17-37. (canceled)

38. The system of claim 1, the container comprising a base portion having an inner compartment holding the flexible package, the inner compartment comprising an angled surface on which the flexible package rests, the angled surface sloping upwards from a first side of the inner compartment to a second side of the inner compartment.

39. The system of claim 38, wherein the flexible package has one or more vents near a top portion thereof, the package being positioned within the container such that the one or more vents is adjacent to the second side of the inner compartment and faces away from the angled surface.

40-43. (canceled)

44. The system of claim 38, wherein the angled surface of the inner compartment is concave in a direction transverse to the slope of the angled surface.

45. A container in the form of a clamshell, the container being penetrable to microwaves, wherein the container is adapted not to experience heat-induced damage when subjected to a heating cycle in a combination microwave and convection oven, the container comprising a base portion having an inner compartment comprising an angled surface sloping upwards from a first side of the inner compartment to a second side of the inner compartment, the container further comprising a lid portion pivotally connected to the base portion and a wall surrounding the inner compartment, wherein the lid portion, when slightly raised, overlaps with the wall, maintaining a complete enclosure around the inner compartment.

46. The container of claim 45, wherein the angled surface of the inner compartment is concave in a direction transverse to the slope of the angled surface.

47. The container of claim 45, wherein the container is made from a polymer resistant to heat-induced damage at an ambient temperature of 540° F.

48-49. (canceled)

50. The container of claim 45, wherein the angled surface is oriented at an angle of from 5° to 45° relative to a horizontal surface supporting the container.
